(19) United States
(12) Patent Application Publication
(10) Pub. No.: US 2025/0350631 A1
(43) Pub. Date: Nov. 13, 2025

(54) Inter-Domain Routing Anomaly Detection Method Based on Network Representation Learning

(71) Applicants: TSINGHUA UNIVERSITY, Beijing (CN); China Telecom Cybersecurity Technology Co., Ltd., Suzhou (CN)

(72) Inventors: Qi Li, Beijing (CN); Yihao Chen, Beijing (CN); Qilei Yin, Beijing (CN); Ke Xu, Beijing (CN); Zhuotao Liu, Beijing (CN); Yi Xu, Beijing (CN); Mingwei Xu, Beijing (CN); Ziqian Liu, Suzhou (CN); Jianping Wu, Beijing (CN)

(21) Appl. No.: 19/202,146

(22) Filed: May 8, 2025

(30) Foreign Application Priority Data
May 8, 2024 (CN) 202410563992.2

(51) Int. Cl. H04L 9/40; H04L 41/0631; H04L 41/0681; H04L 41/16; H04L 45/02; H04L 45/036

(52) U.S. Cl. CPC H04L 63/1458; H04L 41/064; H04L 41/0681; H04L 41/16; H04L 45/036; H04L 45/04; H04L 45/08

(57) ABSTRACT

An inter-domain routing anomaly detection method based on network representation learning, comprises: performing network representation learning of Internet autonomous system relationships under an offline condition; monitoring a routing change of a plurality of inter-domain routing vantage points in real time, updating global routing in response to receiving a border gateway protocol update message, and recording a routing change when the routing change is detected; in response to detecting the routing change, calculating a path difference value before and after the routing change, and when the path difference value is greater than a threshold, determining that the routing change is an abnormal routing change; and performing attribution on the abnormal routing change, aggregating the abnormal routing change into an abnormal event, and issuing an alarm.

### CROSS-REFERENCE TO RELATED APPLICATION

This application claims priority to and benefits of Chinese Patent Application Serial No. 202410563992.2, filed with the State Intellectual Property Office of P. R. China on May 8, 2024, the entire content of which is incorporated herein by reference.

### TECHNICAL FIELD

The disclosure relates to the field of inter-domain routing protocol security, and in particular to an inter-domain routing anomaly detection method based on network representation learning.

### BACKGROUND

The Border Gateway Protocol (BGP) is an important basic protocol to ensure the interconnection between domains of the global Internet. The current inter-domain routing standard of the Internet is BGPv4 defined by RFC4271 and other specifications. It standardizes the code of conduct for exchanging routing and reachability information between autonomous systems (AS) and is widely deployed around the world. It is one of the basic infrastructures for the normal operation of the Internet. As a path vector protocol, the BGP allows the AS to announce its IP address prefix and update routes by exchanging routing control information with adjacent A Ss, based on multi-level local policies. Since there are often specific service relationships between adjacent A Ss, these service relationships are reflected in the local policies of the A Ss and may also affect rout selection and access control of the BGP.

### SUMMARY

The present disclosure proposes an inter-domain routing anomaly detection method based on network representation learning. The method includes:
performing network representation learning of Internet autonomous system relationships under an offline condition;
monitoring a routing change of a plurality of inter-domain routing vantage points in real time, updating global routing in response to receiving a border gateway protocol update message, and recording a routing change when the routing change is detected;
in response to detecting the routing change, calculating a path difference value before and after the routing change, and when the path difference value is greater than a threshold, determining that the routing change is an abnormal routing change; and
performing attribution on the abnormal routing change, aggregating the abnormal routing change into an abnormal event, and issuing an alarm.

The present disclosure proposes an inter-domain routing anomaly detection system based on network representation learning. The system includes: a processor, and a memory for storing a computer program. The processor is configured to perform the above inter-domain routing anomaly detection method based on network representation learning.

Additional aspects and advantages of the present disclosure will be given in part in the description below, and in part will become apparent from the description below, or will be learned through the practice of the present disclosure.

### BRIEF DESCRIPTION OF THE DRAWINGS

The above and/or additional aspects and advantages of the present disclosure will become apparent and easily understood from the following description of the embodiments in conjunction with the accompanying drawings.

FIG. 1 is a flow chart of an inter-domain routing anomaly detection method based on network representation learning according to an embodiment of the present disclosure.

FIG. 2 is a flow chart of an inter-domain routing anomaly detection method based on network representation learning according to an embodiment of the present disclosure.

FIG. 3 is a flow chart of an inter-domain routing anomaly detection method based on network representation learning according to an embodiment of the present disclosure.

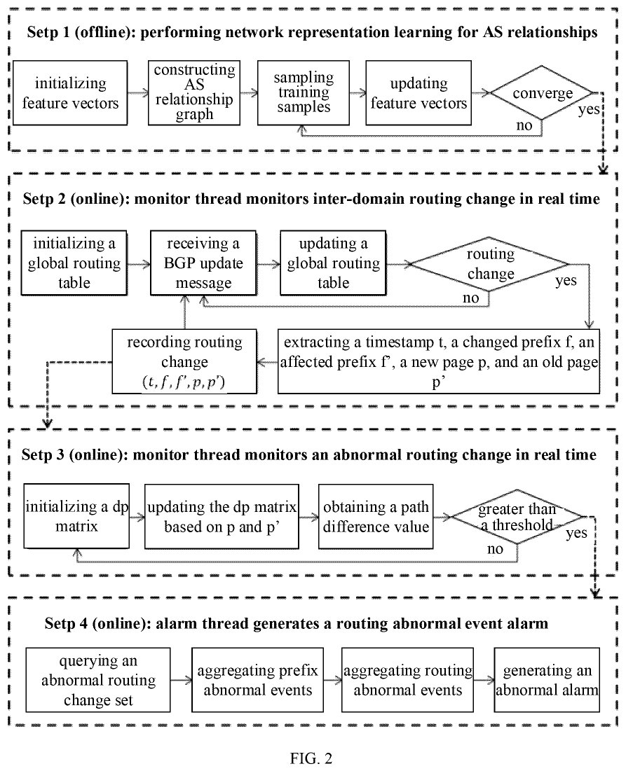

In FIG. 2: solid arrows represent the execution process, and dotted arrows represent information transfer between threads.

### DETAILED DESCRIPTION

The embodiments of the present disclosure are described in detail below, and examples of the embodiments are shown in the accompanying drawings, in which the same or similar reference numerals throughout represent the same or similar elements or elements having the same or similar functions. The embodiments described below with reference to the accompanying drawings are exemplary and are intended to explain the present disclosure, and should not be construed as limiting the present disclosure.

The BGP protocol itself does not provide any security guarantee, so its security issues are characterized by diversity, complexity, wide impact, and great threat and destructiveness. The main security issues of the BGP currently include prefix hijacking and route leakage. The prefix hijacking refers to the traffic sent to a prefix in the Internet being forwarded to a wrong AS or passing through a wrong AS path due to incorrect routing information. Specifically, in the actual network space, whether it is a malicious AS or a misconfigured AS, it may mistakenly announce an IP address prefix that is not legally owned by it or an AS path that does not conform to the actual situation. Since the BGP lacks a security mechanism to identify and filter these abnormal announcements, these incorrect routing information may continue to spread and reside in the routing table of an affected BGP router, causing normal Internet traffic to be forwarded to the wrong AS or passing through the wrong AS path, thereby forming denial of service, interception, middleman and other attacks, seriously affecting the availability and security of Internet upper-layer applications. In addition, another BGP security issue is route leakage. The route leakage refers to the propagation of route announcement beyond the propagation range limited by the AS local policy, resulting in the forwarding path of Internet traffic being contrary to the local policy of the AS it passes through. Specifically, driven by routing forwarding performance or business interests, the local policy of the AS often limits the propagation range of its route announcement, that is, the AS may propagate the route announcement to specific neighbors based on specific routing information. When the AS violates the local policy due to misconfiguration and propagates the route announcement to neighbors that should not be propagated, it may lead to a decline in routing performance or damage to its business interests, which may have a great impact on the normal operation of the Internet.

To this end, the purpose of the present disclosure is to propose an inter-domain routing anomaly detection method based on network representation learning, which realizes real-time, fine-grained and accurate identification of routing hijacking and routing leakage from the perspective of BGP anomaly detection.

The following describes an inter-domain routing anomaly detection method based on network representation learning according to an embodiment of the present disclosure with reference to the accompanying drawings.

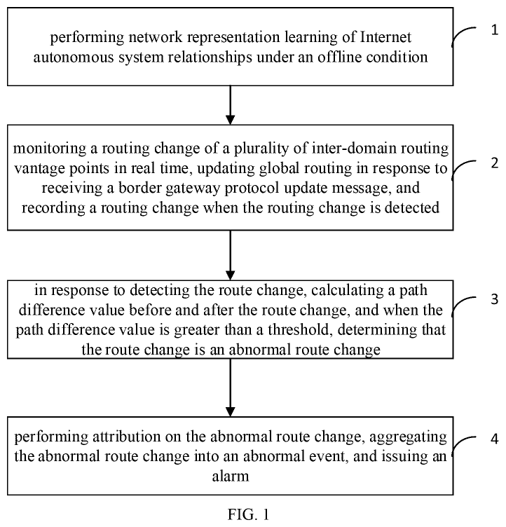

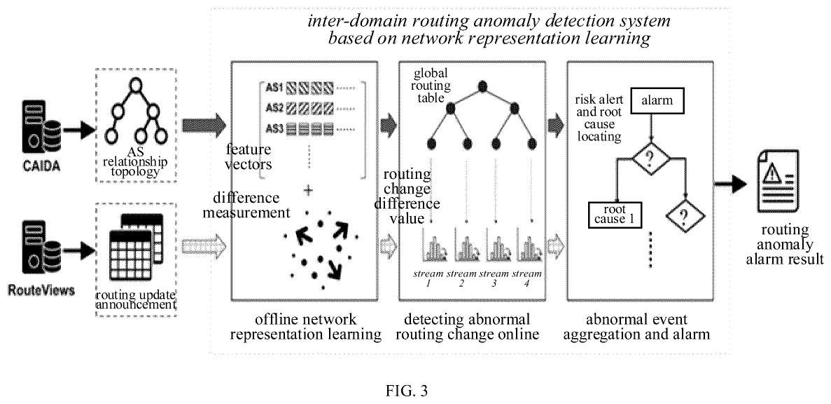

FIG. 1, FIG. 2, and FIG. 3 are respectively an overall flow chart, a detailed flow chart, and a graphical flow chart of an inter-domain routing anomaly detection method based on network representation learning according to an embodiment of the present disclosure. As shown in FIG. 1, the method includes the following steps.
Step 1, network representation learning of Internet autonomous system relationships is performed under an offline condition.

The step 1 includes the following steps.
Step 11, a directed graph is constructed using relationship data of the autonomous systems.

In an embodiment of the present disclosure, the directed graph is first constructed using the relationship data of the autonomous systems.

In an embodiments of the disclosure, the autonomous system relationships may be service interaction relationships between autonomous systems, and the relationship data of the autonomous systems may include service interaction data between the autonomous systems.

Firstly, the directed graph G=(V, E) is initialized, where V represents a node set of the directed graph G, and E represents a directed edge set of the directed graph G; then, nodes are constructed by identifying all autonomous systems appearing in the relationship data of the autonomous systems by their autonomous system identifiers, and the nodes are added to the node set V.

For any pair of nodes u and v in the node set V, if there is a P2C relationship between autonomous systems corresponding the nodes u and v, a directed edge e=(u, v) is added to the directed edge set E. For any pair of nodes u and v in the node set V, if there is a P2P relationship between the autonomous systems corresponding the nodes u and v, directed edges e=(u, v) and e′=(v, u) are added to the directed edge set E.
Step 12, feature vectors corresponding to autonomous system nodes in the directed graph are initialized, sample training samples through the directed graph, optimize the feature vectors for each group of training samples, and obtain updated feature vectors on all training samples.

In an embodiment of the present disclosure, after obtaining the directed graph constructed based on the relationship data of the autonomous systems, for each node u in the node set V, a d-dimensional floating-point vector xᵤ is randomly initialized as a feature vector of the node u, a d-dimensional floating-point vector l is randomly initialized as a weight vector globally, and a d-dimensional floating-point vector r is randomly initialized as a direction vector.

For each node pair (u, v) with a directed edge, Q node pairs (u′, v′) without any directed edge are randomly sampled, and each obtained group ((u, v), (u′, v′)) are used as a training sample.

The feature vectors xu, xv, xu′ and xv may be optimized for each group of training samples ((u, v), (u′, v′)). The specific optimization process is as follows.

s1(u, v) and s1(u′, v′) are calculated, where a score function s1(i,j)=(xⱼ−xᵢ)^{T}((xⱼ−xᵢ)⊙l), where xᵢ and xⱼ in the function represent feature vectors of nodes i and j respectively, ⊙ represents element-by-element multiplication of vectors, (xⱼ−xᵢ)^{T} represents a transpose of (xⱼ−xᵢ), and l is the weight vector.

s2(u, v) and s2(u′, v′) are calculated, where a score function s2(i, j)=(xⱼ−xᵢ)^{T}r, (xⱼ−xᵢ)^{T} represents a transpose of (xⱼ−xᵢ), xᵢ and xⱼ in the function represent the feature vectors of nodes i and j respectively, and r is the direction vector.

An objective function is optimized using stochastic gradient descent to obtain the optimized feature vectors for all training samples. The expression of the objective function is:

$$- log σ ( s 1 ( u , v ) + s 2 ( u , v ) - s 1 ( {u}^{′} , {v}^{′} ) - s 2 ( {u}^{′} , {v}^{′} ) )$$

where, log is a logarithmic operation, and σ is the sigmoid function.
Step 13, it is determined whether training converges based on a decrease of a loss function value, if not, repeating the process of training sample sampling and feature vector updating until the training converges.

It can be understood that after obtaining the optimized feature vectors, it is determined whether the training converges based on the decrease of the loss function value. If not, the process of training sample sampling and feature vector updating is repeated until the training converges. If it has converged, the step can be ended to obtain the final updated feature vectors.
Step 2, a routing change of multiple inter-domain routing vantage points is monitored in real time, global routing is updated in response to receiving a border gateway protocol update message, and a routing change is recorded when the routing change is detected.

In an embodiment of the present disclosure, a global routing table M and a routing change database Db are first initialized by monitoring the routing changes of multiple inter-domain routing vantage points in real time.

When the border gateway protocol update message is received, that is, when a border gateway protocol (BGP) update message is received in real time from N inter-domain routing vantage points, for each received BGP update message, a timestamp t, an IP prefix f and an autonomous system path p={aₙ, aₙ₋₁, . . . , a₁, a₀} are extracted, where, aᵢ is an identifier of an autonomous system through which the message passes, aₙ is an identifier of an autonomous system of the vantage point that receives the routing information, and a₀ is an identifier of a source autonomous system that sends the message, and 0≤i≤n.

Then, the global routing table M is updated and it is checked whether a routing change occurs. When a routing change is detected, a current routing change is recorded.

As a possible implementation, the process of checking whether a routing change occurs is as follows.

The longest parent prefix f′ of f of the routing information with an vantage point an and corresponding routing information p′ are queried through the global routing table M, where f′ and f can be the same.

If p≠p′, it is determined that a routing change (t, f, f′, p, p′) is detected, and the routing change (t, f, f′, p, p′) is recorded in the database Db, and the routing information of prefix f at the vantage point aₙ in the global routing table M is updated to p.
Step 3, in response to detecting the routing change, a path difference value before and after the routing change is calculated, and when the path difference value is greater than a threshold, it is determined that the routing change is an abnormal routing change.

In an embodiment of the present disclosure, for the routing change (t, f, f′, p, p′) detected in step 2, where p={aₙ, aₙ₋₁, . . . , a₁, a₀} and p′={a′ₘ, a′ₘ₋₁, . . . , a′₁, a′₀}, an (n+1)×(m+1) floating point matrix dp is initialized, where a value of dp[0,0] is set to 0 and the other values are set to +∞.

Then, dp[i, j] is calculated in sequence, 1≤i≤n, 1≤j≤m, where for each dp[i, j], the calculation method is as follows.

It is initialized that i=1, j=1, Diff=D(p[i], p′[j]) is calculated, a minimum value among dp[i−1, j], dp[i, j−1] and dp[i−1, j−1] is selected as MinValue, and Diff+MinValue is determined as the value of dp[i, j]. During the iterative calculation process, if i=n and j=m, it means that the value of dp has been calculated. Otherwise, if j<m, it is updated that j=j+1, and the next iterative calculation is re-executed. Otherwise, it is updated that i=i+1, j=1 and the next iterative calculation is re-executed.

Finally, the final calculated value of dp[n, m] is determined as an autonomous system path change difference value of the routing change (t, f, f′, p, p′).

As a possible implementation, if the autonomous system path change difference value is greater than a preset difference threshold, the routing change (t, f, f′, p, p′) is recorded as an abnormal routing change and used in subsequent steps, otherwise it is recorded as a normal routing change.
Step 4: attribution is performed on the abnormal routing change, the abnormal routing change is aggregated into an abnormal event, and an alarm is issued.

The step 4 includes the following steps.
Step 41, prefix abnormal events ev are aggregated.

In an embodiment of the present disclosure, the latest abnormal routing change information (t₀, f₀, f′₀, p₀, p′₀) that is newly generated and not analyzed is extracted, and the latest abnormal routing change information (t₀, f₀, f′₀, p₀, p′₀) is recorded as having been analyzed. The database Db is queried to obtain an abnormal routing change set, wherein each abnormal routing change (t, f, f′, p, p′) in the abnormal routing change set satisfies |t−t₀|<T, f=f₀, and T is a preset size of an analysis window. The number of autonomous system identifiers of different vantage points in the abnormal routing change set is counted, and if the number is greater than a preset number threshold, the abnormal routing change set is recorded as a prefix abnormal event ev to the database Db, and subsequent steps are executed.

It can be understood that the prefix abnormal event is a collection of abnormal routing changes, and the prefix abnormal event aggregation method may set the size T of the analysis window and the number threshold of autonomous system identifiers of different vantage points.
Step 42, routing abnormal events are aggregated, and a root cause identifier of the prefix abnormal events ev are extracted.

In an embodiment of the present disclosure, for each abnormal routing change (t, f, f′, p, p′) in the prefix abnormal events, a symmetric difference set pΔp′ of the autonomous system path is calculated, and an intersection of the symmetric difference sets of the autonomous system paths of all abnormal routing changes in the prefix abnormal events ev is calculated. After adding f and f′ to the intersection, the intersection is used as the root cause identifier of the prefix abnormal events ev.
Step 43, a time interval of the prefix abnormal event ev is calculated, wherein the time interval takes the minimum timestamp of the abnormal routing changes in the prefix abnormal events ev as the starting time point, and takes the maximum timestamp of the abnormal routing changes in the prefix abnormal events ev as the ending time point;
Step 44, a maximum prefix abnormal event set is obtained by querying the database Db, wherein the maximum prefix abnormal event set comprises the prefix abnormal event ev and satisfies that each prefix abnormal event therein has a non-empty intersection with at least another prefix abnormal event in the maximum prefix abnormal event set in terms of time interval and root cause identifier, and determining the maximum prefix abnormal event set as a routing abnormal event to generate the alarm.

It can be understood that the routing abnormal event is a collection of prefix abnormal events, and the routing abnormal event aggregation method may calculate the symmetric difference set of all autonomous system paths with abnormal routing changes, the intersection of the symmetric difference sets of all autonomous system paths with abnormal routing changes, and the time interval of the prefix abnormal events.

In addition, based on the embodiments shown in this disclosure, this disclosure implements a demonstration system. The demonstration system collects autonomous system relationship data from CAIDA to construct an autonomous system relationship topology, and performs offline network representation learning to obtain feature vectors and difference metrics. Multi-vantage point routing update announcements are obtained from the international project RouteViews in real time, routing changes are detected based on the global routing table, and path difference values are calculated to detect abnormal routing changes online. Whenever an abnormal routing change is detected, it is aggregated into a prefix event based on the prefix, and the root cause identifier is calculated for the prefix event, the routing anomaly is aggregated, and an alarm is generated. The detection threshold is automatically calculated through an inflection point of the historical data distribution, and the analysis window size is set to 2 hours.

In the one month after the detection system started running, a total of 152,493,303 route update announcements were processed, 5,106,442 routing changes were detected online, and 548 alarms were generated. Through verification, a total of 497 real abnormal events were identified, including prefix source hijacking, prefix path hijacking, route leakage, ROA misconfiguration and other anomalies, and the detection delay was mostly within 1 minute.

The technical solution provided by the embodiments of the present disclosure brings at least the following beneficial effects:
(1) No reliance on manual configuration: The present disclosure only uses the relationship information of the autonomous system to construct a network representation learning model in advance, and can perform anomaly detection without specific configuration information;
(2) High scalability: The present disclosure establishes information input by monitoring the routing changes of multiple inter-domain routing vantage points, which can be rapidly deployed incrementally and has high scalability.
(3) Real-time detection: The present disclosure monitors the routing changes of multiple vantage points in real time and performs anomaly detection by quickly calculating the path difference value before and after the routing change. The detection delay is low and can meet the needs of real-time detection.
(4) Low false alarm rate: The present disclosure uses a network representation learning method to accurately represent the feature vectors of the autonomous system, which can prevent benign multi-source announcements from being falsely reported as abnormalities, achieving a low false alarm rate.
(5) Universality: The present disclosure transforms routing anomaly detection into detecting significant path differences before and after the routing change, which can detect prefix hijacking and routing leakage at the same time, which is universal.
(6) Interpretability: The present disclosure aggregates the abnormal routing changes into an abnormal event and issues an alarm by associating the prefix and the autonomous system, making the alarm interpretable.

It should be understood that the various forms of processes shown above can be used to reorder, add or delete steps. For example, the steps recorded in this disclosure can be executed in parallel, sequentially or in different orders, as long as the expected results of the technical solution of this disclosure can be achieved, and this document is not limited here.

The above specific implementations do not constitute a limitation on the protection scope of this disclosure. It should be understood by those skilled in the art that various modifications, combinations, sub-combinations and substitutions can be made according to design requirements and other factors. Any modifications, equivalent substitutions and improvements made within the spirit and principles of this disclosure should be included in the protection scope of this disclosure.

What is claimed is:

1. An inter-domain routing anomaly detection method based on network representation learning, comprising:
performing network representation learning of Internet autonomous system relationships under an offline condition;
monitoring a routing change of a plurality of inter-domain routing vantage points in real time, updating global routing in response to receiving a border gateway protocol update message, and recording a routing change when the routing change is detected;
in response to detecting the routing change, calculating a path difference value before and after the routing change, and when the path difference value is greater than a threshold, determining that the routing change is an abnormal routing change; and
performing attribution on the abnormal routing change, aggregating the abnormal routing change into an abnormal event, and issuing an alarm.

2. The method of claim 1, wherein performing network representation learning of Internet autonomous system relationships under the offline condition comprises:
constructing a directed graph using relationship data of autonomous systems;
initializing feature vectors corresponding to autonomous system nodes in the directed graph, obtaining training samples by sampling the directed graph, performing feature vector optimization for each group of training samples, and obtaining updated feature vectors for all training samples; and
determining whether training converges based on a decrease of a loss function value, and if the training does not converge, repeating processes of training sample sampling and feature vector updating until the training converges.

3. The method of claim 2, wherein constructing the directed graph using relationship data of the autonomous systems comprises:
initializing the directed graph G=(V, E), where V represents a node set of the directed graph G, and E represents a directed edge set of the directed graph G;
constructing nodes by identifying all autonomous systems appearing in the relationship data of the autonomous systems by autonomous system identifiers, and adding the nodes to the node set V;
for any pair of nodes u and v in the node set V, if there is a P2C relationship between autonomous systems corresponding the nodes u and v, adding a directed edge e=(u, v) to the directed edge set E; and
for any pair of nodes u and v in the node set V, if there is a P2P relationship between the autonomous systems corresponding the nodes u and v, adding directed edges e=(u, v) and e′=(v, u) to the directed edge set E.

4. The method of claim 3, wherein initializing feature vectors corresponding to autonomous system nodes in the directed graph, obtaining training samples by sampling the directed graph, performing feature vector optimization for each group of training samples, and obtaining updated feature vectors for all training samples, comprises:
for each node u in the node set V, randomly initializing a d-dimensional floating-point vector xᵤ as a feature vector of the node u;
randomly initializing a d-dimensional floating-point vector l as a weight vector, and randomly initializing a d-dimensional floating-point vector r as a direction vector;
for each node pair (u, v) with a directed edge, randomly sampling Q node pairs (u′, v′) without any directed edge, and determining each obtained group ((u, v), (u′, v′)) as a training sample;
calculating s1(u, v) and s1(u′, v′) for each training sample ((u, v), (u′, v′)), where, a score function s1(i, j)=(xⱼ−xᵢ)^{T}((xⱼ−xᵢ)⊙l), where xᵢ and xⱼ in the function represent feature vectors of nodes i and j respectively, (represents element-by-element multiplication of vectors, (xⱼ−xᵢ)^{T} represents a transpose of (xⱼ−xᵢ), and l is the weight vector;
calculating s2(u, v) and s2(u′, v′) for each training sample ((u, v), (u′, v′)), where a score function s2(i, j)=(xⱼ−xᵢ)^{T}r, (xⱼ−xᵢ)^{T} represents a transpose of (xⱼ−xᵢ), xᵢ and xⱼ in the function represent the feature vectors of nodes i and j respectively, and r is the direction vector; and
optimizing an objective function using stochastic gradient descent, obtaining optimized feature vectors for all training samples, where an expression of the objective function is:
$$- log σ ( s 1 ( u , v ) + s 2 ( u , v ) - s 1 ( {u}^{′} , {v}^{′} ) - s 2 ( {u}^{′} , {v}^{′} ) )$$
where, log is a logarithmic operation, and σ is the sigmoid function.

5. The method of claim 4, wherein monitoring the routing change of the plurality of inter-domain routing vantage points in real time, updating global routing in response to receiving the border gateway protocol update message, and recording the routing change when the routing change is detected, comprises:
initializing a global routing table M and a routing change database Db;
receiving the border gateway protocol update message in real time from N inter-domain routing vantage points, where N>1;
for each received BGP update message, extracting a timestamp t, an IP prefix f and an autonomous system path p={aₙ, aₙ₋₁, . . . , a₁, a₀}, where, aᵢ is an identifier of an autonomous system through which the message passes, aₙ is an identifier of an autonomous system of the vantage point that receives routing information, and a₀ is an identifier of a source autonomous system that sends the message, and 0≤i≤n; and p′
updating the global routing table, checking whether a routing change occurs, and recording a current routing change when the routing change is detected.

6. The method of claim 5, wherein checking whether a routing change occurs, and recording a current routing change when the routing change is detected, comprises:
querying a longest parent prefix f′ of the f of the routing information with an vantage point aₙ and corresponding routing information p′ through the global routing table M, where f′ and f is the same; and
if p≠p′, determining that a routing change (t, f, f′, p, p′) is detected, recording the routing change (t, f, f′, p, p′) in the routing change database Db, and updating the routing information of prefix f at the vantage point an in the global routing table M to p.

7. The method of claim 6, wherein, in response to detecting the routing change, calculating a path difference value before and after the routing change, and when the path difference value is greater than a threshold, determining that the routing change is an abnormal routing change, comprises:
for the routing change (t, f, f′, p, p′) detected, initializing an (n+1)×(m+1) floating point matrix dp, where p={aₙ, aₙ₋₁, . . . , a₁, a₀} and p′={a′ₘ, a′ₘ₋₁, . . . , a′₁, a′₀}, where a value of dp[0,0] is set to 0 and the other values are set to +∞; and
calculating dp[i, j] in sequence, where 1≤i≤n, 1≤j≤m, where for each dp[i,j], a calculation method comprises:
initializing i=1, j=1, calculating Diff=D(p[i], p′[j]), selecting a minimum value among dp[i−1, j], dp[i, j−1] and dp[i−1, j−1] as MinValue, and determining Diff+MinValue as a value of dp[i, j], wherein, during an iterative calculation process, if i=n and j=m, it is determined that a value of dp has been calculated; if j<m, it is updated that j=j+1, and the next iterative calculation is re-executed, otherwise, it is updated that i=i+1, j=1 and the next iterative calculation is re-executed;
determining a final calculated value of dp[n, m] as an autonomous system path change difference value of the routing change (t, f, f′, p, p′); and
if the autonomous system path change difference value is greater than a preset difference threshold, recording the routing change (t, f, f′, p, p′) as an abnormal routing change, if the autonomous system path change difference value is less than or equal to the preset difference threshold, recording the routing change (t, f, f′, p, p′) as a normal routing change.

8. The method of claim 7, wherein performing attribution on the abnormal routing change, aggregating the abnormal routing change into an abnormal event, and issuing an alarm, comprises:
aggregating prefix abnormal events ev;
aggregating routing abnormal events, and extracting a root cause identifier of the prefix abnormal events ev;
calculating a time interval of the prefix abnormal events ev, wherein the time interval takes a minimum timestamp of the abnormal routing changes in the prefix abnormal events ev as a starting time point, and takes a maximum timestamp of the abnormal routing changes in the prefix abnormal events ev as an ending time point; and
obtaining a maximum prefix abnormal event set by querying the database Db, wherein the maximum prefix abnormal event set comprises the prefix abnormal event ev and satisfies that each prefix abnormal event therein has a non-empty intersection with at least another prefix abnormal event in the maximum prefix abnormal event set in terms of time interval and root cause identifier, and determining the maximum prefix abnormal event set as a routing abnormal event to generate the alarm.

9. The method of claim 8, wherein aggregating prefix abnormal events ev comprises:
extracting latest abnormal routing change information (t₀, f₀, f′₀, p₀, p′₀) that is newly generated and not analyzed, and recording the latest abnormal routing change information (t₀, f₀, f′₀, p₀, p′₀) as having been analyzed;
obtaining an abnormal routing change set by querying the routing change database Db, wherein, each abnormal routing change (t, f, f′, p, p′) in the abnormal routing change set satisfies |t−t₀|<T, f=f₀, and T is a preset size of an analysis window; and
counting a number of autonomous system identifiers of different vantage points in the abnormal routing change set, and if the number is greater than a preset number threshold, recording the abnormal routing change set as a prefix abnormal event ev to the database Db, and executing subsequent steps.

10. The method of claim 9, wherein aggregating routing abnormal events, and extracting a root cause identifier of the prefix abnormal events ev comprises:
for each abnormal routing change (t, f, f′, p, p′) in the prefix abnormal events, calculating a symmetric difference set pΔp′ of the autonomous system path; and
calculating an intersection of the symmetric difference sets of the autonomous system paths of all abnormal routing changes in the prefix abnormal events ev, determining the intersection as the root cause identifier of the prefix abnormal events ev after adding f and f′ to the intersection.

11. An inter-domain routing anomaly detection system based on network representation learning, comprising:
a processor; and
a memory for storing a computer program;
wherein the processor is configured to perform an inter-domain routing anomaly detection method based on network representation learning, the method comprising:
performing network representation learning of Internet autonomous system relationships under an offline condition;
monitoring a routing change of a plurality of inter-domain routing vantage points in real time, updating global routing in response to receiving a border gateway protocol update message, and recording a routing change when the routing change is detected;
in response to detecting the routing change, calculating a path difference value before and after the routing change, and when the path difference value is greater than a threshold, determining that the routing change is an abnormal routing change; and
performing attribution on the abnormal routing change, aggregating the abnormal routing change into an abnormal event, and issuing an alarm.

12. The system of claim 11, wherein performing network representation learning of Internet autonomous system relationships under the offline condition comprises:
constructing a directed graph using relationship data of autonomous systems;
initializing feature vectors corresponding to autonomous system nodes in the directed graph, obtaining training samples by sampling the directed graph, performing feature vector optimization for each group of training samples, and obtaining updated feature vectors for all training samples; and
determining whether training converges based on a decrease of a loss function value, and if the training does not converge, repeating processes of training sample sampling and feature vector updating until the training converges.

13. The system of claim 12, wherein constructing the directed graph using relationship data of the autonomous systems comprises:
initializing the directed graph G=(V, E), where V represents a node set of the directed graph G, and E represents a directed edge set of the directed graph G;
constructing nodes by identifying all autonomous systems appearing in the relationship data of the autonomous systems by autonomous system identifiers, and adding the nodes to the node set V;
for any pair of nodes u and v in the node set V, if there is a P2C relationship between autonomous systems corresponding the nodes u and v, adding a directed edge e=(u, v) to the directed edge set E; and
for any pair of nodes u and v in the node set V, if there is a P2P relationship between the autonomous systems corresponding the nodes u and v, adding directed edges e=(u, v) and e′=(v, u) to the directed edge set E.

14. The system of claim 13, wherein initializing feature vectors corresponding to autonomous system nodes in the directed graph, obtaining training samples by sampling the directed graph, performing feature vector optimization for each group of training samples, and obtaining updated feature vectors for all training samples, comprises:
for each node u in the node set V, randomly initializing a d-dimensional floating-point vector xᵤ as a feature vector of the node u;
randomly initializing a d-dimensional floating-point vector l as a weight vector, and randomly initializing a d-dimensional floating-point vector r as a direction vector;
for each node pair (u, v) with a directed edge, randomly sampling Q node pairs (u′, v′) without any directed edge, and determining each obtained group ((u, v), (u′, v′)) as a training sample;
calculating s1(u, v) and s1(u′, v′) for each training sample ((u, v), (u′, v′)), where, a score function s1(i, j)=(xⱼ−xᵢ)^{T}((xⱼ−xᵢ)⊙l), where xᵢ and xⱼ in the function represent feature vectors of nodes i and j respectively, ⊙ represents element-by-element multiplication of vectors, (xⱼ−xᵢ)^{T} represents a transpose of (xⱼ−xᵢ), and l is the weight vector;
calculating s2(u, v) and s2(u′, v′) for each training sample ((u, v), (u′, v′)), where a score function s2(i, j)=(xⱼ−xᵢ)^{T}r, (xⱼ−xᵢ)^{T} represents a transpose of (xⱼ−xᵢ), xᵢ and xⱼ in the function represent the feature vectors of nodes i and j respectively, and r is the direction vector; and
optimizing an objective function using stochastic gradient descent, obtaining optimized feature vectors for all training samples, where an expression of the objective function is:
$$- log σ ( s 1 ( u , v ) + s 2 ( u , v ) - s 1 ( {u}^{′} , {v}^{′} ) - s 2 ( {u}^{′} , {v}^{′} ) )$$
where, log is a logarithmic operation, and σ is the sigmoid function.

15. The system of claim 14, wherein monitoring the routing change of the plurality of inter-domain routing vantage points in real time, updating global routing in response to receiving the border gateway protocol update message, and recording the routing change when the routing change is detected, comprises:
initializing a global routing table M and a routing change database Db;
receiving the border gateway protocol update message in real time from N inter-domain routing vantage points, where N>1;
for each received BGP update message, extracting a timestamp t, an IP prefix f and an autonomous system path p={aₙ, aₙ₋₁, . . . , a₁, a₀}, where, aᵢ is an identifier of an autonomous system through which the message passes, aₙ is an identifier of an autonomous system of the vantage point that receives routing information, and a₀ is an identifier of a source autonomous system that sends the message, and 0≤i≤n; and p′
updating the global routing table, checking whether a routing change occurs, and recording a current routing change when the routing change is detected.

16. The system of claim 15, wherein checking whether a routing change occurs, and recording a current routing change when the routing change is detected, comprises:
querying a longest parent prefix f′ of the f of the routing information with an vantage point aₙ and corresponding routing information p′ through the global routing table M, where f′ and f is the same; and
if p≠p′, determining that a routing change (t, f, f′, p, p′) is detected, recording the routing change (t, f, f′, p, p′) in the routing change database Db, and updating the routing information of prefix f at the vantage point aₙ in the global routing table M to p.

17. The system of claim 16, wherein, in response to detecting the routing change, calculating a path difference value before and after the routing change, and when the path difference value is greater than a threshold, determining that the routing change is an abnormal routing change, comprises:
for the routing change (t, f, f′, p, p′) detected, initializing an (n+1)×(m+1) floating point matrix dp, where p={aₙ, aₙ₋₁, . . . , a₁, a₀} and p′={a′ₘ, a′ₘ₋₁, . . . , a′₁, a′₀}, where a value of dp[0,0] is set to 0 and the other values are set to +∞; and
calculating dp[i, j] in sequence, where 1≤i≤n, 1≤j≤m, where for each dp[i, j], a calculation method comprises:
initializing i=1, j=1, calculating Diff=D(p[i], p′[j]), selecting a minimum value among dp[i−1, j], dp[i, j−1] and dp[i−1, j−1] as MinValue, and determining Diff+MinValue as a value of dp[i, j], wherein, during an iterative calculation process, if i=n and j=m, it is determined that a value of dp has been calculated; if j<m, it is updated that j=j+1, and the next iterative calculation is re-executed, otherwise, it is updated that i=i+1, j=1 and the next iterative calculation is re-executed;
determining a final calculated value of dp[n, m] as an autonomous system path change difference value of the routing change (t, f, f′, p, p′); and
if the autonomous system path change difference value is greater than a preset difference threshold, recording the routing change (t, f, f′, p, p′) as an abnormal routing change, if the autonomous system path change difference value is less than or equal to the preset difference threshold, recording the routing change (t, f, f′, p, p′) as a normal routing change.

18. The system of claim 17, wherein performing attribution on the abnormal routing change, aggregating the abnormal routing change into an abnormal event, and issuing an alarm, comprises:
aggregating prefix abnormal events ev;
aggregating routing abnormal events, and extracting a root cause identifier of the prefix abnormal events ev;
calculating a time interval of the prefix abnormal events ev, wherein the time interval takes a minimum timestamp of the abnormal routing changes in the prefix abnormal events ev as a starting time point, and takes a maximum timestamp of the abnormal routing changes in the prefix abnormal events ev as an ending time point; and
obtaining a maximum prefix abnormal event set by querying the database Db, wherein the maximum prefix abnormal event set comprises the prefix abnormal event ev and satisfies that each prefix abnormal event therein has a non-empty intersection with at least another prefix abnormal event in the maximum prefix abnormal event set in terms of time interval and root cause identifier, and determining the maximum prefix abnormal event set as a routing abnormal event to generate the alarm.

19. The system of claim 18, wherein aggregating prefix abnormal events ev comprises:
extracting latest abnormal routing change information (t₀, f₀, f′₀, p₀, p′₀) that is newly generated and not analyzed, and recording the latest abnormal routing change information (t₀, f₀, f′₀, p₀, p′₀) as having been analyzed;
obtaining an abnormal routing change set by querying the routing change database Db, wherein, each abnormal routing change (t, f, f′, p, p′) in the abnormal routing change set satisfies |t−t₀|<T, f=f₀, and T is a preset size of an analysis window; and
counting a number of autonomous system identifiers of different vantage points in the abnormal routing change set, and if the number is greater than a preset number threshold, recording the abnormal routing change set as a prefix abnormal event ev to the database Db, and executing subsequent steps.

20. The system of claim 19, wherein aggregating routing abnormal events, and extracting a root cause identifier of the prefix abnormal events ev comprises:
for each abnormal routing change (t, f, f′, p, p′) in the prefix abnormal events, calculating a symmetric difference set pΔp′ of the autonomous system path; and
calculating an intersection of the symmetric difference sets of the autonomous system paths of all abnormal routing changes in the prefix abnormal events ev, determining the intersection as the root cause identifier of the prefix abnormal events ev after adding f and f′ to the intersection.
